(19) United States
(12) Patent Application Publication
(10) Pub. No.: US 2007/0080148 A1
(43) Pub. Date: Apr. 12, 2007

(54) Short-pulsed laser treatment for angularity adjust with minimized heat loading of a hard disk drive component

(76) Inventors: Toshiki Hirano, San Jose, CA (US); Chie C. Poon, San Jose, CA (US); Gurinder P. Singh, San Jose, CA (US); Timothy C. Strand, San Jose, CA (US)

Correspondence Address: WAGNER, MURABITO & HAO LLP;Third Floor, Two North Market Street, San Jose, CA, 95113, US

(21) Appl. No.: 11/246,038

(22) Filed: Oct. 7, 2005

(51) Int. Cl. B23K 26/00; B21D 37/16

(52) U.S. Cl. 219/121.85; 72/342.1; 72/342.94; 219/121.83

(57) ABSTRACT

An apparatus for producing a heat affected zone in at least one thin surface layer of metal of a component suitable for use in an HDD comprises: a radiation device for generating a first beam of pulsed laser radiation; an optical device for transmitting the first beam of pulsed laser radiation to the metal on the surface of the component; a first control system for determining the amount of the pulsed laser radiation required to produce a controlled heat affected zone in at least one thin surface layer of metal of the component; and a second control system for determining the location of the pulsed laser radiation on the surface of the component. The embodied apparatus does not require CW laser radiation in conjunction with the pulsed laser radiation to cause bi-directional angular deflection of a free end of the component. The first control system of the apparatus has a determiner configured to determine exposure variables of the first beam of pulsed laser radiation required to cause the component to become concave towards the laser irradiated side. The determiner is also configured to determine exposure variables of a second beam of pulsed laser radiation required to cause the component to become concave towards the laser irradiated side.

### TECHNICAL FIELD

The present invention relates to an apparatus and method for adjusting the gram load and static attitude of a slider in a head gimbal assembly of a magnetic hard disk drive and more particularly to an apparatus and method that utilize a laser to melt a thin layer of metal in one or more small regions of a suspension.

### BACKGROUND ART

Direct access storage devices (DASD) have become part of every day life, and as such, expectations and demands continually increase for greater speed for manipulating and holding larger amounts of data. To meet these demands for increased performance, the mechanical assembly in a DASD device, specifically the Hard Disk Drive (HDD) and its sub-assemblies continue to evolve.

HDDs that utilize a magnetic transducer, or head, mounted on a slider for reading and writing data on at least one rotatable magnetic disk are well known in the art. In such HDDs, the slider is typically attached to an actuator arm by a suspension system. The slider with its head flies above the rotating disk surface. Flying is accomplished by virtue of the aerodynamic design of the slider; the attitude of the slider to the disk surface; the load applied to the slider, referred to as gram load; and the rotation of the spinning magnetic disk. The combination of the slider and suspension system is referred to as a Head Gimbal Assembly or HGA.

As the storage density of magnetic disks increases, it is necessary to decrease the flying height below the heights conventionally used. For example, in disks with storage densities of 1 to 2 GB/in², the required flying height is in the range of 35 to 50 nm. Storage density is currently approaching 100 GB/in². The required flying height must decrease commensurately to about 10 nm.

The suspension industry has transitioned from suspension designs that required signal conducting wires, or leads to be added at a higher level of assembly. Current designs now have signal conducting leads integrated into the suspension. There are several technologies used for producing integrated lead suspensions. For the purpose of discussion, all Integrated Lead Suspensions will be referred to as ILS. This invention is independent of the technology used to produce an ILS.

One parameter associated with the head's ability to fly above the disk surface is the load applied from the suspension to the slider, or gram load. The industry practice in the past, for adjusting the gram load, was to adjust the gram load to a predetermined value before the head and signal conducting leads were attached. The process involved preforming the suspension to produce a higher gram load than desired for operation in the HDD. Through a series of localized heating steps with focused high intensity infrared light, measuring the gram load, and heating the entire suspension for stress relieving, the gram load was set and adjusted to its desired value. In this manner, gram load could only be decreased from its preformed condition.

Another parameter associated with the head's ability to fly above the disk surface is a parameter known as static attitude. Static attitude is the angular relationship of the slider to the disk surface. Tilting of the slider around its axis that is oriented circumferentially to the disk is referred to as Roll Static Attitude (RSA). Tilting of the slider around its axis that is oriented radially to the disk is referred to as Pitch Static Attitude (PSA). PSA and RSA are orthogonal to each other. Changes in PSA will cause the magnetic head attached to the distal end of the slider to tilt closer or farther from the disk surface. Changes in either PSA or RSA will change the manner in which the slider flies above the disk surface. In the past, PSA and RSA were adjusted in a similar manner to that of the gram load of the suspension. All sliders then, as they are today, are attached to the suspension in an area of the suspension known as the gimbal, or flexure. The flexure is typically made of steel that is thinner than the rest of the suspension. The flexure is much less rigid than the other parts of the suspension and thus allows the slider to fly over the disk surface with a minimal resistance to movement in the pitch or roll directions. Areas of the flexure were mechanically formed and then heated to stabilize the adjusted static attitude.

Suspension gram load and static attitude produce mechanical forces that allow the slider to fly above the disk surface. These forces are in balance with another force that is created by the rotating disk and the aerodynamic shape of the surface of the slider. This force is known as an air bearing force. The aerodynamic surface on the slider, which is parallel and adjacent to the rotating disk surface, is referred to as the Air Bearing Surface or ABS. The slider and ABS continue to shrink in size in order to meet the demands for lower flying and higher volume of data stored. The forces that are in balance between the suspension and the air bearing force are becoming increasingly smaller and more challenging to control.

The preceding described processes for establishing a desirable suspension gram load and static attitude had many years of success in the industry. These processes were also adapted for use with thin-film heads and signal conducting leads attached to the suspension. The evolution of HGA technology, mainly the introduction of magneto-resistive (MR) heads and ILS, has made these processes obsolete. MR heads cannot tolerate the elevated temperatures required by the aforementioned methods of adjusting the gram load and its static attitude. The elevated temperatures had adverse effects on the structure of the integrated leads of the ILS.

The processes for adjusting the gram load and static attitude have also evolved. Currently, micro heating with lasers has solved the problems associated with heating sensitive areas of the ILS as well the slider with its MR and GMR (giant magneto-resistive) head.

Ubl et al. in U.S. Pat. No. 6,837,092 teaches in part, a method for heating localized areas of suspension material with a rapidly scanned continuous wave (CW) laser and thus creating stress that warps the suspension to achieve a desired suspension form (from here on referred to as Ubl). Girard et al. in U.S. Pat. No. 5,682,780 teaches in part an alternate approach, where the suspension is mechanically clamped to the position of desired suspension gram load and static attitude thus creating mechanical stress, and annealing with CW laser radiation to stabilize that position (from here on referred to as Girard). Singh et al. in U.S. Pat. Nos. 5,712,463 and 6,011,239 similarly teaches in part, a method of creating stress in a suspension with short pulses of laser irradiation and annealing these stresses with long pulses or CW laser irradiation thus causing the suspension to achieve a desired suspension form and flying characteristic of the head (from here on referred to as Singh). Continuing increases in storage density and the commensurate decreases in fly height will also make these methods obsolete.

Other methods are known for adjusting the flying height of the slider. For example, Pohl et al., in U.S. Pat. No. 4,853,810, disclose the use of a tunnel current electrode for adjusting the flying height. Owe et al., in U.S. Pat. No. 5,012,369, disclose the use of a suspension having a screw for adjusting the flying height. IBM Technical Disclosure Bulletin, vol. 34, no. 10B, p. 242-244 (March 1992), discloses an automated fly height tester that utilizes a robot to position the head suspension assembly on a quartz disk where the gram load is adjusted mechanically or with an infrared gram load adjustment system. With the exception of Ube, Girard, and Singh, these methods have not been amenable to high volume manufacturing.

In order that the slider can fly at a lower fly height to accomplish the increases in storage density, the slider has become smaller. Consequently the suspension has also become smaller and the steel that it is made from has also become thinner. Tolerances in suspension gram load and static attitude that were acceptable for slider flying in the 35 to 50 nm range are no longer acceptable for sliders flying 10 nm and lower. The prior art that teaches in part the use of high-powered CW lasers, scanning and heating the suspension surface rapidly, are too powerful for the thinner steel being required in today's smaller and thinner suspensions.

The methods taught in part by Ubl, Girard and Singh are to change the angles of the suspension that effect suspension gram load and static attitude by irradiate the suspension with a high-wattage CW laser. Through experimentation, it has been found that irradiation with high-wattage doses of focused energy are changing the angles of the suspension by relieving stresses in the steel of the suspension. This stress relieving is known as annealing.

There are two primary sources of stresses in the suspension. The first source is a result of the process used to create the thin sheets of steel from which the suspension is made. Thicker steel is passed multiple times through a series of rollers to create thin sheets of steel. The thinning of the steel flows the steel and creates stress. The rolling stress varies widely between batches of thinly rolled steel as well as the location of the steel in the roll of steel. The second source of stress is the forming and bending processes that give the suspension its shape. The stresses caused by the suspension manufacturing process are more consistent, but still can vary due to differences in the forming and bending processes. Stresses are required in the suspension for the suspension to act as an appropriate spring for applying a suspension gram load as well as for providing the gimbal motion of the flexure. Annealing small surfaces on the suspension without knowing the inherent stress level in the steel or its probable variation from one surface to the other will result in inconsistent angle changes in the suspension and undesirable results. These inconsistencies require iterative irradiation of a CW laser to achieve the desired results.

Iterative irradiation with a CW laser has been possible for the past several years due to the larger and thicker suspensions used. The depth (d) that heat from a laser penetrates a surface is proportional to the square root of the time of irradiation (t) from the laser; d∝t^{1/2}. The problem that results from excessively deep heat penetration is that annealing of the steel's unknown stresses will result in variations of suspension angles. At its extreme, annealing will remove the spring characteristics of the suspension. Deep penetration of heat results from long duration of laser irradiation, such as that radiated by a CW laser. In order to minimize the depth of heat penetration, a CW laser is scanned rapidly. However, the power, or wattage, of the CW laser must also be sufficient to produce an adequate amount of heat to affect the desired change. CW operation requires very high scan rates, on the order of 1 m/s or more, to avoid deep heat penetration. This in turn requires high laser powers, on the order of 10 W, to deliver adequate heating to the part. Thus for a CW laser scanned at the high velocity of 1 m/s with a 40 micron spot, a penetration depth on the order of 30 microns is expected. This exceeds the total thickness of today's new smaller and thinner flexures. Scanning at high velocity so as to reduce the depth of laser penetration presents the challenge of stopping the CW laser before it irradiates and damages sensitive areas of the ILS. If irradiation with a CW laser is attempted at the HGA level of assembly, the added challenge of avoiding irradiation of the sensitive slider and its head is presented.

### SUMMARY OF THE INVENTION

An apparatus for producing a heat affected zone in at least one thin surface layer of metal of a component suitable for use in an HDD comprises: a radiation device for generating a first beam of pulsed laser radiation; an optical device for transmitting the first beam of pulsed laser radiation to the metal on the surface of the component; a first control system for determining the amount of the pulsed laser radiation required to produce a controlled heat affected zone in at least one thin surface layer of metal of the component; and a second control system for determining the location of the pulsed laser radiation on the surface of the component. The embodied apparatus does not require CW laser radiation in conjunction with the pulsed laser radiation to cause bi-directional angular deflection of a free end of the component.

The first control system of the apparatus has a determiner configured to determine exposure variables of the first beam of pulsed laser radiation required to cause the component to become concave towards the laser irradiated side. The determiner is also configured to determine exposure variables of a second beam of pulsed laser radiation required to cause the component to become concave towards the laser irradiated side.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a side view of a suspension assembly in the unloaded position;

FIG. 2 is a side view of a Head Gimbal Assembly (HGA) in the unloaded position;

FIG. 3 is a side view of a Head Stack Assembly (HSA) in the unloaded position;

FIG. 4 is a side view of an HGA in the loaded position against a disk;

FIG. 5 is a side view of an HGA in the loaded position against a pin;

FIG. 6 is an end view of the head suspension assembly shown in FIG. 5;

FIG. 7 is a side view of a head suspension assembly illustrating the flying height of the slider;

FIG. 8a is a plan view of the load beam side of an ILS HGA;

FIG. 8b is a plan view detail of the ABS side of a flexure of an ILS HGA;

FIG. 8c is a plan view detail of a preferred zone for receiving pulsed laser radiation on a flexure of an ILS HGA;

FIG. 9 is a schematic diagram of an apparatus for producing a heat affected zone in at least one thin surface layer of metal on a suspension according to the present invention;

FIG. 10a is a graphical representation of the depth of penetration of a laser beam to produce a heat affected zone;

FIG. 10b is a diagrammatic representation of the depth of penetration of a laser beam and the resulting concave bend towards the side of irradiation according to the present invention.

FIG. 11 is a process flow diagram embodied in the present invention.

### DETAILED DESCRIPTION

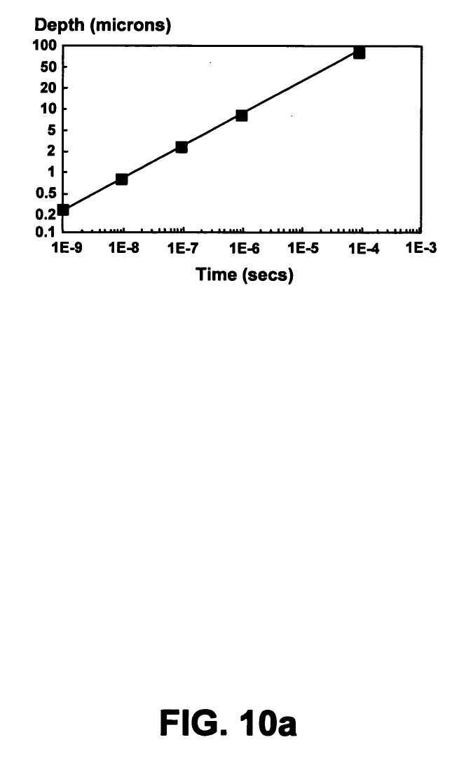

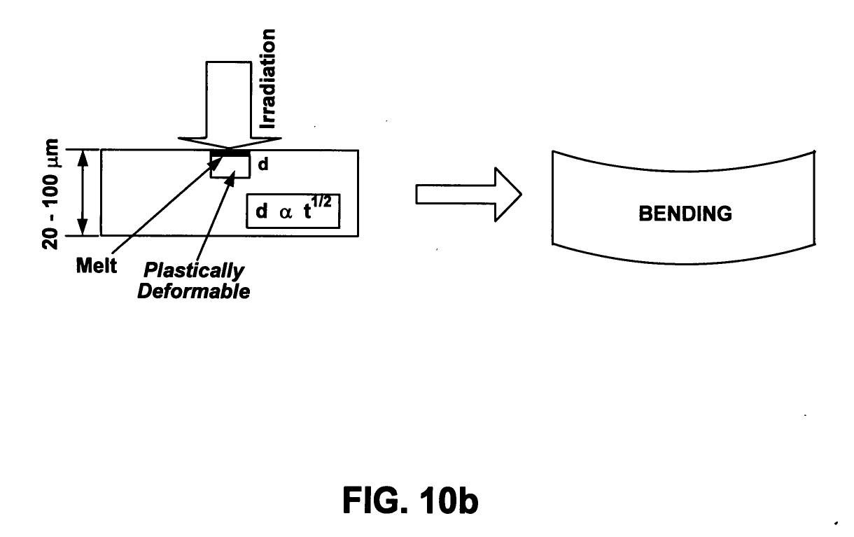

It is the goal of the embodied invention to address the challenges presented by the cited prior art while achieving accuracy and high manufacturing volume in a cost effective manner. In particular, the embodied invention teaches an apparatus and method of producing a heat affected zone in at least one thin surface layer of metal. Referring to FIG. 10, a heat affected zone is defined as that area in a metal surface wherein the most closest surface of the metal being irradiated by a laser is melted and the penetration of heat into the metal is such that the bulk of the material is not heated, inherent stresses are not annealed, and an angular change is affected in the metal of the irradiated component. The metal of a component suitable for use in an HDD can be composed of any number of metals, alloys or laminates and is not limited to the historic use stainless steel in HDD components. The term metal used indicates, but is not limited to stainless steel, high strength copper alloy, other metals, alloys, and laminates. The metal used in a component suitable for use in an HDD by no means limits this invention. The principle of angular change resulting from laser irradiation is well understood and described in Singh et al. in U.S. Pat. Nos. 5,712,463 and 6,011,239.

Any feature of an assembly or an assembly that is defined by its function, whether it be made from the same contiguous material of another feature or is attached to another feature, is by definition a component suitable for use in an HDD. To avoid repetitive use of the word “component,” the definition of the word “component” is to be implied and understood when an assembly, feature, or part is described and assigned a numerical identifier.

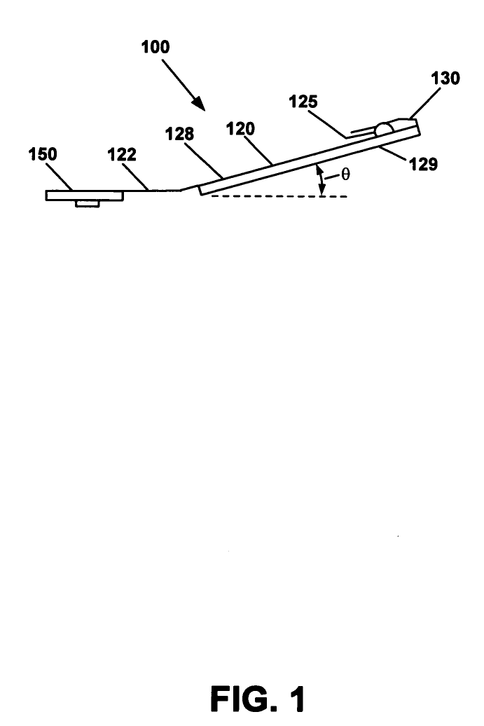

FIG. 1 is an illustration of an HDD component known as suspension assembly 100. Suspension assembly 100 is comprised in part of: load beam 120, mount plate 150, and flexure 130. Load beam 120 includes a hinge region 122, which is connected to mount plate 150. Hinge region 122 is bent such that load beam 120 is rotated at angle θ relative to mount plate 150. Load beam 120 comprises in part dimple 125, which will transfer the load from hinge region 122, via load beam 120 to slider 211. Load beam 120 has a top side 128 and a bottom side 129. Top side 128 is the side of load beam 120 on which flexure 130 is attached, and bottom side 129 is the side of load beam 120 opposite to top side 128. Flexure 130 comprises in part a flexure tongue 131 to which slider 211 will be attached.

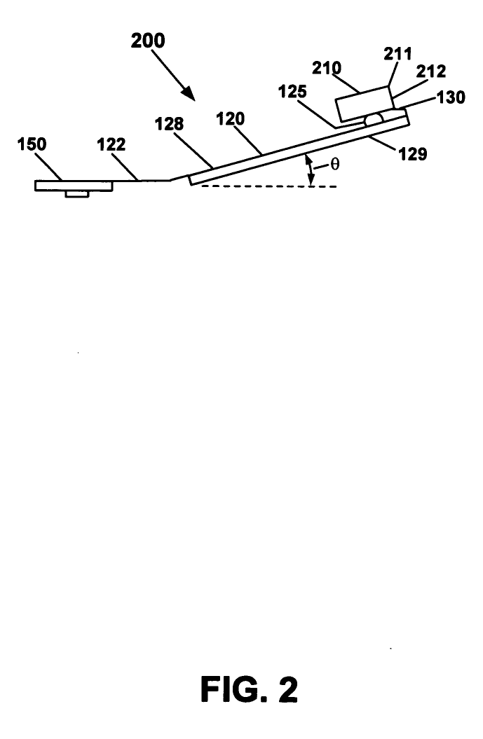

FIG. 2 is an illustration of an HDD component known as a Head Gimbal Assembly 200 (referred to as HGA 200). HGA 200 is comprised in part of suspension assembly 100 and slider 211. Slider 211 includes front surface 212 and air-bearing surface 210 (referred to as ABS 210).

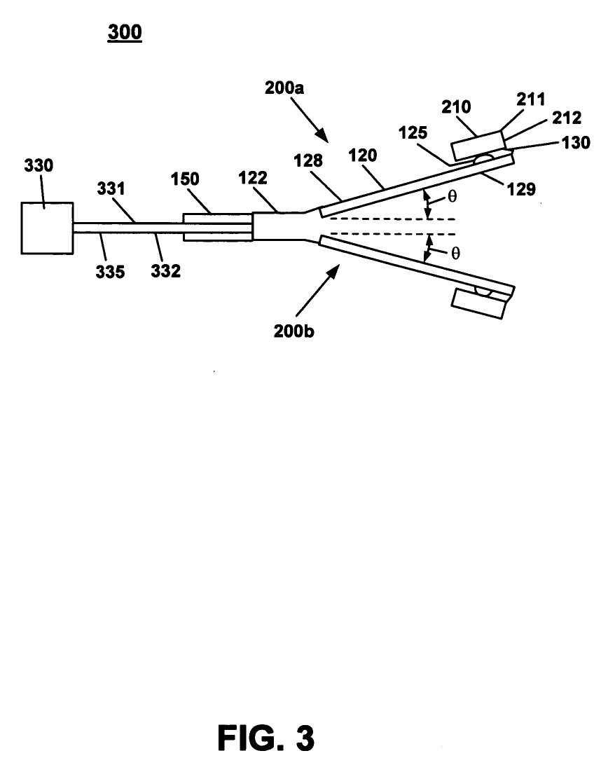

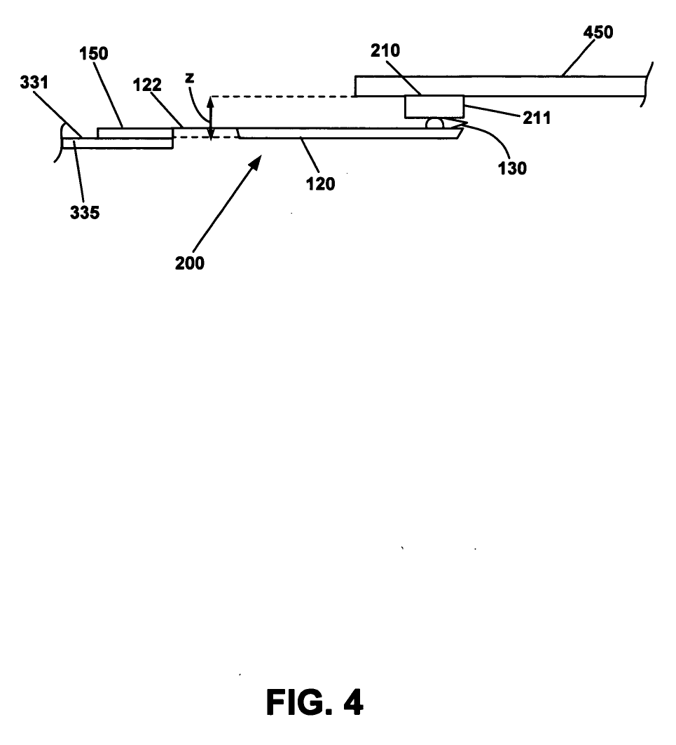

FIG. 3 is an illustration of an HDD component known as a Head Stack Assembly 300 (referred to as HSA 300). HSA 300 comprises in part an HGA 200a attached oppositely to HGA 200b. It is understood that HSA 300 can have from one to a plurality of HGAs attached. The number of attached HGAs does not limit the extent of this invention. HGA 200a is attached to surface 331 of arm 335 by means of mount plate 150. HGA 200b is a mirror image of HGA 200a and is attached to surface 332 of arm 335. Surface 331 is that surface which is parallel and opposite to surface 332. Arm 335 is part of actuator 330. It is understood that actuator 330 can be configured to have a plurality of arms 335, which in no way limits the scope of this invention. Actuator 330 functions to move slider 211 relative to a surface of hard magnetic disk 450 (shown in FIG. 4) or other magnetic storage medium. Slider 211 includes one or more data transducers, or heads, for reading and writing data on magnetic disk 450. Slider 211 is attached to load beam 120 by flexure 130 and flexure tongue 131. Dimple 125 applies the load of suspension 100 to slider 211.

FIG. 4 illustrates the relationship of HGA 200 to disk 450 when disk 450 is not rotating. In the configuration shown in FIG. 4, HGA 200 is said to be in the “loaded” position. In the loaded position, disk 450 bends load beam 120 and flexure 130 down so that the angle θ between load beam 120 and mount plate 150, is close to zero. Because the hinge region 122 resists this deformation, the gram load is transmitted through load beam 120 and dimple 130 to slider 211. The distance between the ABS 210 of slider 211 and top surface 331 of arm 335 is called the z height. In the case of suspension 100, where slider 211 and actuator arm 335 are not present, the distance between the bottom of mount plate 150 to the top of flexure tongue 131 is called the z height.

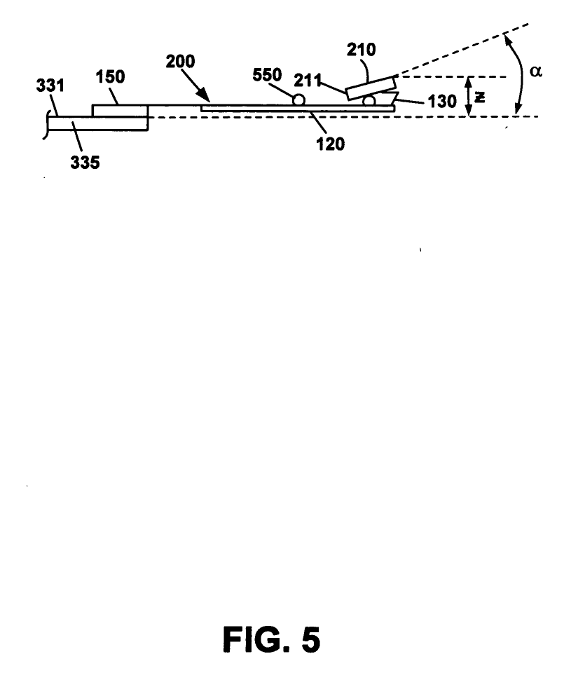

FIG. 5 illustrates HGA 200 held in the loaded position by an external means such as a pin 550. Normally top surface 331 is parallel to the plane of disk 450. In this configuration, angle a is defined by ABS 210 and top surface 331 as is illustrated in FIG. 5. Angle α is referred to as the Pitch Static Attitude (PSA) of slider 211. In the case of suspension 100, where slider 211 and actuator arm 335 are not present, the angle between the bottom of mount plate 150 and the top of the flexure 130 is called PSA of the flexure.

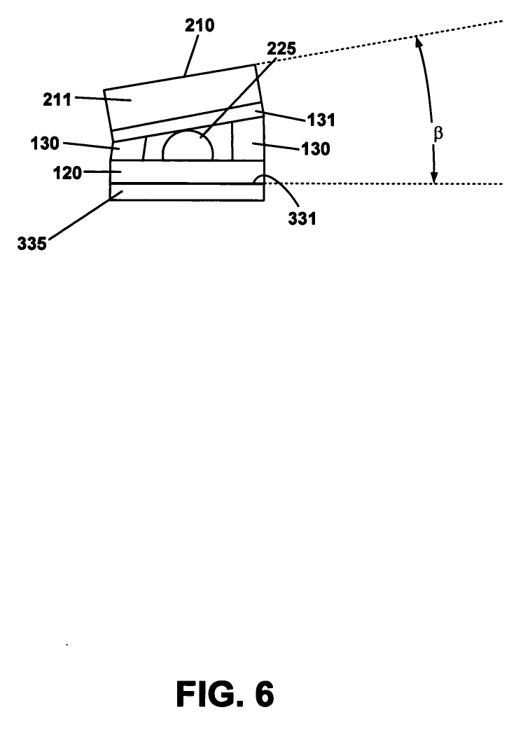

FIG. 6 is an end view of HGA 200 with HGA 200 held in the loaded position as described in FIG. 5. In this configuration, angle β is defined by ABS 210 and top surface 331 as illustrated in FIG. 6. Angle β is referred to as the Roll Static Attitude (RSA) of slider 211. In the case of suspension 100, where slider 211 and actuator arm 335 are not present, the angle between the bottom of mount plate 150 and the top of the flexure 130 is called RSA of the flexure. The term “static attitude” is used to describe both PSA and RSA together. The definitions for the angles α and β used in FIGS. 5 and 6 assume that slider 211 has its head positioned on the front surface 212. However, similar definitions apply if the head is positioned on the side of slider 211 or internal to slider 211.

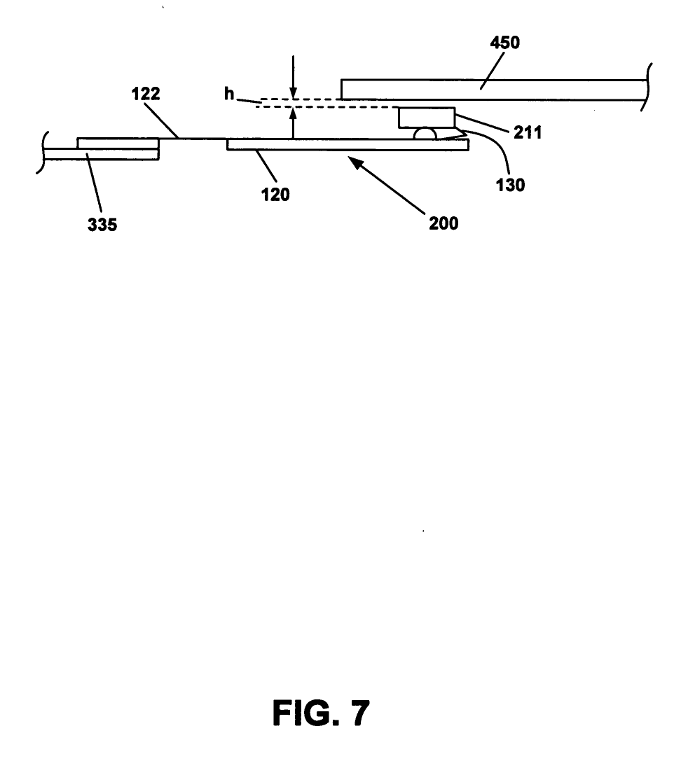

FIG. 7 illustrates the relationship of the HGA 200 to the disk 450 when the disk 450 is rotating. The rotation of the disk 450 causes slider 211 to be positioned a distance “h” from the surface of the disk 450. The distance “h” is referred to as the slider “flying height” and represents the position that slider 211 occupies when the disk 450 is rotating during normal operation of a disk file. If flying height “h” is not maintained within a certain range, the quality of the data read from disk 450 (or written on disk 450) degrades. Several factors contribute flying height “h”. For example, when disk 450 is rotating, the rotation of disk 450 creates a force (called an air bearing force) that pushes the slider 211 away from the disk 450. The gram load transmitted by the load beam 120 and the torque exerted by the flexure 130 oppose the air bearing force. Therefore, adjustments to the angles θ, α and β contribute to the final value of the flying height “h” Typically, the angle θ is set at some predetermined value during the manufacturing process and provides the coarse positioning of the slider 211 which allows flying height “h” to be maintained when the disk 450 is rotating.

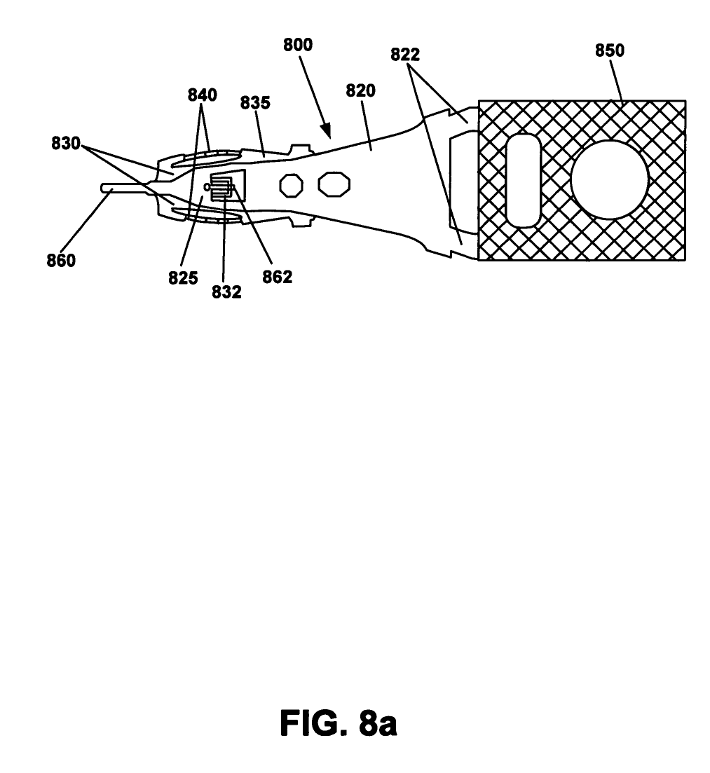

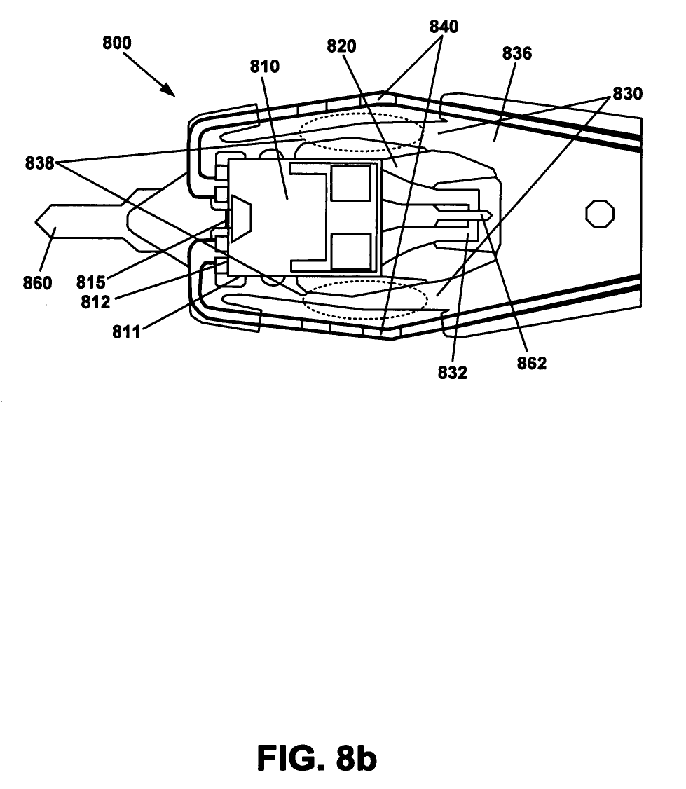

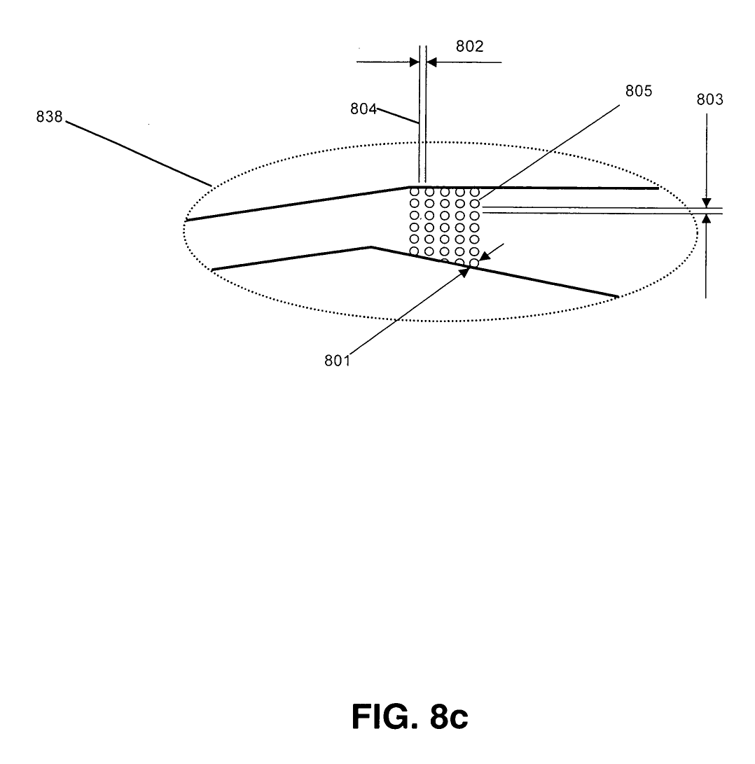

FIG. 8a illustrates a plan view of ILS HGA 800 showing the side of ILS HGA 800 that faces surface 331 of actuator arm 335 (FIG. 3). ILS HGA 800 comprises in part; mount plate 850, load beam 820, and flexure 830. Flexure 830 includes in part; integrated leads 840, flexure surface 835, flexure surface 836 (FIG. 8b), and limiter loop 832. Load beam 820 includes in part; hinge region 822, dimple 825, load/unload tab 860, and limiter tab 862. In FIG. 8a, dimple 825 is seen from its concave side.

FIG. 8b is a detailed plan view of the distal end of ILS HGA 800 showing the side of ILS HGA 800 that faces disk 450. Included in this view, to further present the relationships of the various components; are load beam 820, flexure 830, integrated leads 840, load/unload tab 860, and limiter tab 862. Flexure surface 836 is that surface on which slider 811 is attached. Flexure surface 835 and flexure surface 836 are parallel and opposite to one another. Flexure surface 835 is that surface on which load beam 820 is attached. Also presented in FIG. 8b is slider 811, which includes in part front surface 812, head 815, and ABS 810.

ILS HGA 800 has components and features that are similar in description and function as those presented in FIGS. 1 through 7, namely; mount plate 850, load beam 820, dimple 825, and flexure 830. (A flexure tongue is present but not visible.) ILS HGA 800 also includes integrated leads 840 for conducting electrical signals to and from head 815. ILS HGA 800 also includes load/unload tab 860 for lifting and lowering slider 811 off and on disk 450. ILS HGA 800 also includes limiter tab 862 and limiter loop 832. Limiter tab 862 in conjunction with limiter loop 832 restricts slider 811 from excessive motion during the lifting and lowering operation performed by load/unload tab 860. An ILS has the same levels of assembly analogues to FIGS. 1, 2 and 3. The first level of assembly is an ILS. Adding slider 811 to an ILS constitutes an ILS HGA. Adding one or more ILS HGAs to an actuator constitutes an ILS HSA.

All fabrication procedures, including static attitude adjust, for load beam 820 and flexure 830 affect the relationships of load beam 820 and flexure 830 and the relationship of their components. These relationships are critical for the proper function of an HDD. The relationships of limiter tab 862 to limiter loop 832 as well as their relationship to load/unload tab 860 and to ABS 810 are critical to the proper operation of ILS HGA 800. Limiter tab 862 and limiter loop 832 are formed so that they are in close proximity but are separate to allow slider 811 to gimbal freely about dimple 825. Improper relationships will result in catastrophic failure either during flying of slider 811, or during the lifting and lowering of slider 811 on and off disk 450. Catastrophic failure will take the form of slider 811 not flying properly and contacting disk 450. This failure is known as a “head crash.” Catastrophic failure will also take the form of either slider 811 running into the edge of disk 450 or ABS 810 dragging off the edge of disk 450 when the lifting and lowering of slider 811 is attempted. The methods taught in this invention for producing a heat affected zone in at least one thin surface layer of metal of a component suitable for use in an HDD can be applied to, but are not limited to, limiter tab 862, limiter loop 832, and load/unload tab 860.

FIG. 8c is a detailed plan view of zone 838. Zone 838 is a preferred area of flexure surface 835 and flexure surface 836 for receiving pulsed laser radiation for the purpose of adjusting static attitude. Localized spots of thin layers of steel on flexure surface 835 and flexure surface 836 are melted in multiples of scanned line 804. Scanned line 804 is defined by the direction in which the laser is scanned across flexure surface 835 and flexure surface 836. One skilled in the art will recognize that the pattern of scanned line 804 can be controlled to any location on a surface 835 or surface 836 to achieve a controlled concave bending of flexure 830. Localized melted spots of thin layers of steel are the result of pulsed laser irradiation being scanned across flexure surface 835 and flexure surface 836. Localized melted spots are characterized by spot diameter 801, scanned line spacing 802, and spot spacing 803. Refer to FIG. 10b for a representation of concave bending that occurs towards the surface being irradiated.

The preceding presentation and description of components suitable for use in an HDD demonstrate the need for increasingly tighter dimensional controls on those components that effect gram load, static attitude, limiter tab to loop clearance, and load/unload tab location. The subsequent assembly of a lower level component such as an ILS into a higher-level assembly, such as an ILS HSA, and eventually into an HDD increases the difficulty to control these dimensions. The embodiments of this invention address this need with an apparatus that adjusts a component at a higher level of assembly. The embodiments of this invention are applicable to all levels of component suitable for use in an HDD.

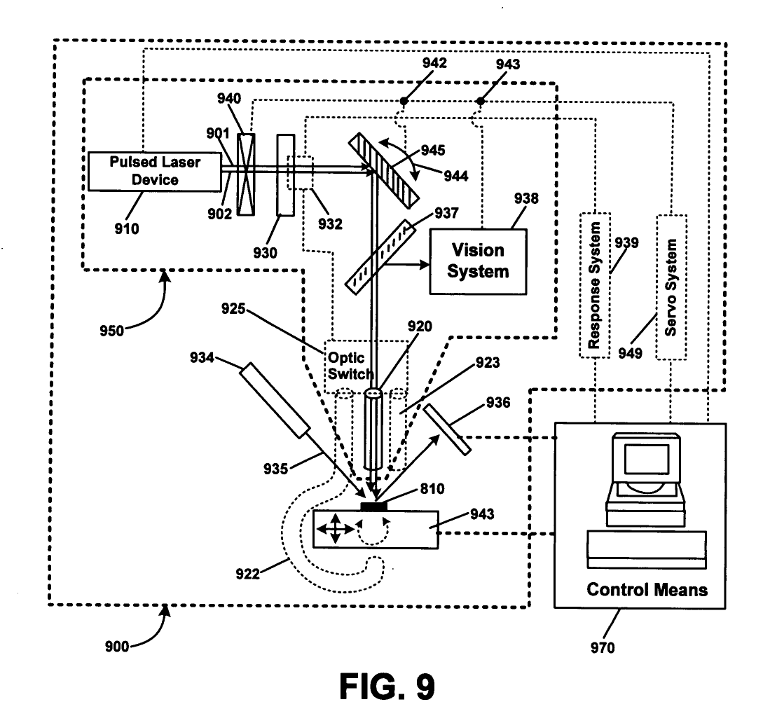

FIG. 9 illustrates a block diagram of apparatus 900 for producing a heat affected zone in at least one thin surface layer of metal of a component suitable for use in an HDD. In the preferred embodiment, the primary purpose of producing a heat affected zone in at least one thin surface layer of metal of a component is to adjust the static attitude of ILS HGA 800. Apparatus 900 can also be used to cause an angular deflection of a free end of any component suitable for use in an HDD. Apparatus 900 comprises: a pulsed laser device 910 for generating a first beam of pulsed laser radiation 901; an optical device 920 for transmitting and focusing first beam of pulsed laser radiation 901 to the steel on surface 836 of ILS HGA 800; a first control system for determining the amount of pulsed laser radiation required to produce a controlled heat affected zone on surface 836; and a second control system for determining the location of the pulsed laser radiation on surface 836 and on surface 835.

In the preferred embodiment, pulsed laser radiation device 910 has a wavelength of about 1 micron. If and when available, shorter wavelength pulsed lasers are preferred. Commercially available lasers suitable for this invention include but are not limited to Nd:YAG (Neodymium:Yttrium-Aluminum-Gamet) and Nd:YLF (Neodymium: Yttrium-Lithium-Fluoride) with 1.06 and 1.05 micron wavelengths respectively. Frequency-doubled versions of these lasers are also suitable for this invention.

The first control system determines the amount of pulsed laser radiation required to produce a controlled heat affected zone in at least one thin surface layer of metal on flexure 830. It consists of: monitor laser 934; monitor diode 936; response system 939; determiner 932; and attenuator 930. Attenuator 930 controls the amount of pulsed laser energy that is delivered to optical device 920. The amount and uniformity of pulsed laser energy that attenuator 930 is to deliver is determined by determiner 932. The amount of pulsed laser energy is controlled to a range of 1 microjoule to 10 milijoules. Determiner 932 also determines whether flexure surface 836 or flexure surface 835 will be irradiated. Determiner 932 receives information from response system 939. Response system 939 analyzes data from monitor diode 936 and compares the data to previously stored database of pulsed laser parameters and expected changes in static attitude. The previously stored database is derived empirically for the various types of ILS HGAs to be manufactured. Monitor diode 936 reads the angular deflection of laser beam 935 as it is radiated from monitor laser 934 and reflected off ABS 810. Monitor laser 934 is typically a laser diode or a Helium-Neon (or HeNe) laser. This invention is independent of the type of monitor laser used.

Because only a thin layer of steel is melted, annealing of the inherent stresses in flexure 830 is avoided. Achieving the desired static attitude is very likely with irradiation from a first beam of pulsed laser radiation 901.

It is possible that the first control system determines that a second beam of pulsed laser radiation 902 is required to satisfy the static attitude requirements of the database stored in response system 939. Determiner 932 will again determine the exposure variables of the second beam of pulsed laser radiation 902 as it did with the first beam of pulsed laser radiation 901.

It is possible that the first control system determines that a second beam of pulsed laser radiation 902 is required to be applied to the opposite flexure surface of flexure 830 to satisfy the static attitude requirements of the database stored in response system 939. In one embodiment determiner 932 communicates to servo system 949 via control means 970 to flip x-y stage 943 to expose the opposite flexure surface to pulsed laser radiation 902. An alternate embodiment is to incorporate a flipping device in x-y stage 943 that would flip ILS HGA 800. In yet another embodiment, determiner 932 in conjunction with optic switch 925 direct pulsed laser radiation 902 to optical device 922 to expose the opposite flexure surface to irradiation. In yet another embodiment, sub-apparatus 950 is duplicated on the opposite side of x-y stage 943. Determiner 932 communicates to control means 970 to activate this duplicate sub-apparatus 950. In the aforementioned embodiments, optical switch 925 and optical devices 920, 922 and 923 can be designed by using various optical components such as mirrors and prisms. Other options are an optical fiber switch 925 and optical fiber lines 920, 922 and 923. This invention is independent of the design of the optical device.

These aforementioned devices and response system 939 work in concert as a first control system to determine the amount of pulsed laser radiation required to produce a controlled heat affected zone in at least one thin surface layer of metal on surface 835 and on surface 836 to effectively adjust ILS HGA 800 static attitude.

The second control system determines the location of pulsed laser radiation 901 and pulsed laser radiation 902 on flexure surface 836 and flexure surface 835. It consists of: shutter 940; galvanometric mirror scanner 945 (referred to as galvo 945); vision system 938; beam splitter 937; servo system 949; and x-y stage 943. Shutter 940 stops and starts pulsed laser radiation 901 and pulsed laser radiation 902. Galvo 945 receives pulsed laser radiation 901 and pulsed laser radiation 902, and oscillates rotationally, which results in scan rate 944 of pulsed laser radiation 901 and pulsed laser radiation 902. Galvo 945 is connected to servo system 949 at connection node 942. Vision system 938 identifies features on ILS HGA 800 to be irradiated. It is connected to servo system 949 at connection node 943. The preferred locations of irradiation on ILS HGA 800 are identified as zones 838 on surface 836 and surface 835 of flexure 830. Beam splitter 937 allows viewing by vision system 938 while allowing pulsed laser radiation 901 and pulsed laser radiation 902 to pass on to optical device 920. Servo system 949, in conjunction with control means 970, positions ILS HGA 800 under optical device 920 via x-y stage 943 in accordance to the image that vision system 938 sees.

These aforementioned devices and servo system 949 work in concert as a second control system to determine the location of pulsed laser radiation required to produce a controlled heat affected zone in at least one thin surface layer of metal on surface 835 and on surface 836 to effectively adjust ILS HGA 800 static attitude. These aforementioned devices and servo system 949 work in concert to confine pulsed laser radiation 901 and pulsed laser radiation 902 to zones 838 on surface 836 and surface 835 of flexure 830 while producing scanned line spacing 802.

Slow scan rate 944 is made possible by irradiating with a pulsed laser device. Slow scan rate 944 allows the second control system to accurately determine the location of pulsed laser radiation 901 and pulsed laser radiation 902. Slow scan rate 944 is possible because of the many combinations of exposure variables and focused laser radiation spot diameters 801 that can produce the controlled melting. The preferred focused laser radiation spot diameter 801 is 1 to 500 microns. The preferred laser pulse rate is in the range of 1 to 3000 Hertz. The preferred laser pulse duration is in the range of 1 to 200 ns. The preferred laser pulse energy is in the range of 1 microjoule to 10 milijoules. These laser and exposure parameters can be combined in various combinations to allow a scan rate 944 that is economical and efficient for galvo 945 to achieve. The preferred scan rate 944 is such that the melted spot spacing 803 is in the range of 0.5 to 3 spot diameters 801. The preferred scanned line spacing 802 is in the range of 0.5 to 10 spot diameters 801. It is possible and in the realm of this invention to have spot diameter 810 and spot spacing 803 to be such that scanned line 804 appears to be a continuous unbroken line. Resulting scanned line 804 would be similar in appearance for both a pulsed laser and a CW laser. However, the heat affected zone is very different between the two lasers.

A CW laser scan will produce a continuously heated scan such that there is no time for the heat to dissipate before the irradiating beam proceeds in its scan. Heat accumulates in the irradiated metal in a manner that is difficult to control. Since the accumulated heat is difficult to control, the effective location of scanned lines 804 is less defined. The CW laser irradiation will anneal the material in a manner that is difficult to control, thus presenting difficulty in adjusting static attitude. With thinner flexures used in today's suspensions, it would be difficult to prevent the heat affected zone from penetrating the total thickness of the flexure.

A pulsed laser scan creates multiples of discrete spot 805. A discrete spot 805 is created with each pulse of pulsed laser device 910. Discrete pulses from pulsed laser 910 have time for heat to dissipate and not accumulate, as is the case with a CW laser. The dissipation of heat for each discrete spot 805 prevents the annealing of stresses in the material and allows for precise control of heat penetration. The precise control of heat penetration allows for more precise control of the effective location of scanned lines 804.

A goal for controlling the heat affected zone is to control its depth to less than one half the thickness of the metal being irradiated. The plastically deformable portion of the heat affected zone (see FIG. 10b) should be kept to a minimum. There should be no annealing. There should be no ablating of the metal surface; i.e. removing of material from the metal surface or generating of particles of metal.

Apparatus 900 does not require CW laser radiation in conjunction with the pulsed laser radiation device to cause bi-directional angular deflection of a free end of a component suitable for use in an HDD. The disadvantages of using a CW laser to adjust static attitude of ILS HGA 800 have been presented to emphasize the advantages of the embodied invention. As previously presented a higher power laser such as a CW laser requires faster scan rates. Faster scan rates make accurate control of the location of laser irradiation very difficult and expensive.

FIG. 10a is a graphic that illustrates the relationship of depth of penetration to the pulse length of the laser. The time component of the graph can be viewed as the pulse duration of a laser. Longer pulse duration results in greater depth of penetration.

FIG. 10b illustrates the depth of penetration of laser pulse irradiation. FIG. 10b demonstrates that the depth of penetration “d” is proportional to the square root of the pulse length of the laser. Laser irradiation causes the metal being irradiated to curve towards the irradiation in a concave manner.

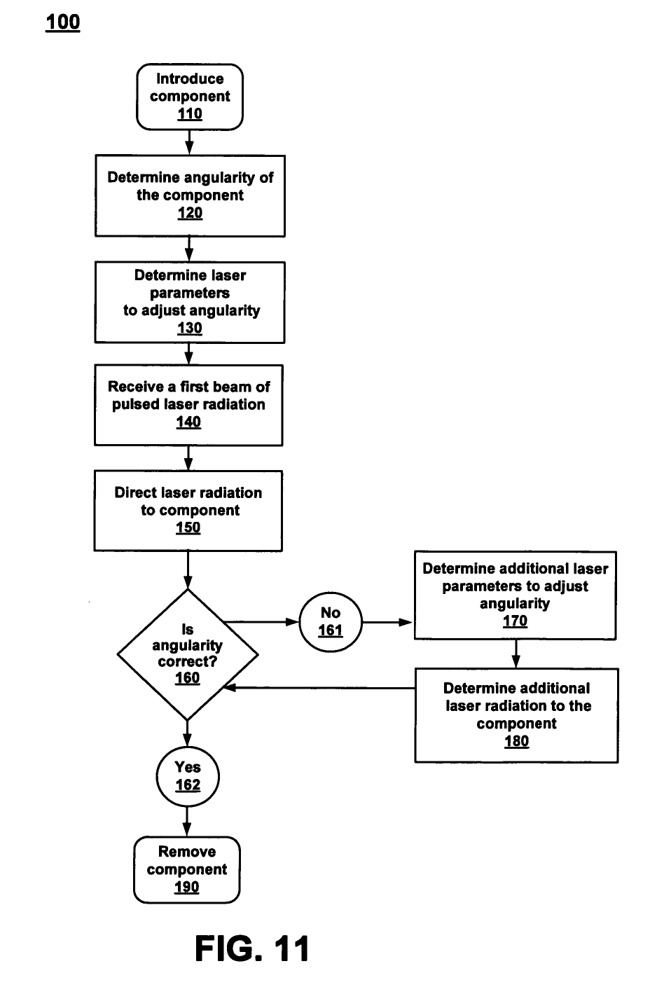

FIG. 11 is a flow chart of a process 100 in which particular steps are performed in accordance with an embodiment of the present invention for producing a heat affected zone in at least one thin surface layer of metal of a component suitable for use in an HDD. FIG. 11 includes processes of the present invention, which in one embodiment, are carried out by processors, electrical components and assembly mechanisms under the control of computer readable and computer executable instructions. The computer readable and computer executable instructions reside, for example, in data storage features such as a computer usable volatile memory and/or a computer usable non-volatile memory and/or a data storage device. However, the computer readable and computer executable instructions may reside in any type of computer readable medium. Although specific steps are disclosed in process 100, such steps are exemplary. That is, the present invention is well suited to performing various other steps or variations of the steps recited in FIG. 11. Within the present embodiment, it should be appreciated that the steps of process 100 may be performed by software, by hardware, by an assembly mechanism, through human interaction, or by any combination of software, hardware, assembly mechanism, and human interaction.

In step 110 of process 100, a component suitable for use in an HDD is introduced into apparatus 900 (as shown in FIG. 9), in an embodiment of the present invention.

In step 120 of process 100, the angularity of the component suitable for use in an HDD is measured, in an embodiment of the present invention.

In step 130 of process 100, the parameters for a pulsed laser device are determined to selectively adjust the angularity of the component, in an embodiment of the present invention.

In step 140 of process 100, a first beam of pulsed laser radiation is received from the pulsed laser device, in an embodiment of the present invention.

In step 150 of process 100, the first beam of pulsed laser radiation is directed to the surface of the component suitable for use in an HDD, in an embodiment of the present invention.

In step 160 of process 100, it is determined whether the angularity of the component has been selectively adjusted correctly. If the component has not been selectively adjusted correctly, process 100 proceeds to step 170. If the component has been selectively adjusted correctly, process 100 proceeds to step 190, in an embodiment of the present invention.

In step 170 of process 100, the parameters for a second beam of pulsed laser radiation are determined, in an embodiment of the present invention.

In step 180 of process 100, the second beam of pulsed laser radiation is directed to the surface of the component suitable for use in an HDD, in an embodiment of the present invention. Steps 160 to 170 can be iterated as needed, but it is a goal of this invention to minimize the number of iterations.

In step 190 of process 100, the component suitable for use in an HDD is removed from apparatus 900 (as shown in FIG. 9), in an embodiment of the present invention.

Advantageously, the present invention, in the various presented embodiments allows for producing a heat affected zone in at least one thin surface layer of metal of a component suitable for use in an HDD without requiring the use of a CW laser. The present invention in the various presented embodiments advantageously allows for cost effective static attitude adjustment of an ILS HGA without jeopardizing the ILS or the sensitive head.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An apparatus for producing a heat affected zone in at least one thin surface layer of metal of a component suitable for use in an HDD comprising:
a radiation device for generating a first beam of pulsed laser radiation;
an optical device for transmitting said first beam of pulsed laser radiation to said metal on said surface of said component;
a first control system for determining the amount of said pulsed laser radiation required to produce a controlled heat affected zone in at least one thin surface layer of metal of said component; and
a second control system for determining the location of said pulsed laser radiation on said surface of said component; wherein said apparatus does not require CW laser radiation in conjunction with said pulsed laser radiation to cause bi-directional angular deflection of a free end of said component.

2. The apparatus of claim 1 wherein said first control system comprises:
a determiner configured to determine exposure variables of said first beam of pulsed laser radiation required to cause said component to become concave towards the laser irradiated side; and
said determiner configured to determine exposure variables of a second beam of pulsed laser radiation required to cause said component to become concave towards the laser irradiated side.

3. The apparatus of claim 1 wherein said first control system further comprises:
a detection system for monitoring the angular deflection of said component;
a response system for adjusting said exposure variables of said first beam of said pulsed laser radiation; and
a response system for adjusting said exposure variables of said second beam of said pulsed laser radiation.

4. The apparatus of claim 1 wherein said second control system further comprises a servo system for controlling:
commencing of said first beam of pulsed laser radiation;
stopping of said first beam of pulsed laser radiation;
commencing of said second beam of pulsed laser radiation; and
stopping of said second beam of pulsed laser radiation.

5. The apparatus of claim 1 wherein said optical device comprises at least one focusing member to focus said first beam of pulsed laser radiation to a spot size adequate for producing said heat affected zone in at least one thin surface layer of metal of said component.

6. The apparatus of claim 1 wherein said optical device comprises at least one optical device for transmitting said second beam of pulsed laser radiation to said metal on surface of said component.

7. The apparatus of claim 1 wherein said optical device comprises at least two optical devices for transmitting:
said first beam of pulsed laser radiation to said metal on said surface of said component; and
said second beam of pulsed laser radiation to an opposite metal surface of said component.

8. A method for producing a heat affected zone in at least one thin surface layer of metal of a component suitable for use in an HDD in which said method comprises:
determining angularity of said component;
determining parameters of pulsed laser radiation to selectively adjust said angularity of said component;
receiving a first beam of pulsed laser radiation;
directing said pulsed laser radiation to said component;
determining parameters for additional pulsed laser radiation to selectively adjust said angularity of said component;
directing said additional pulsed laser radiation to said component.

9. The method of claim 8 wherein said parameters of pulsed laser radiation comprise:
a pulse duration in the range of 1 to 200 ns;
a pulse rate in the range of 1 to 3000 Hertz; and
a pulse energy in the range of 1 microjoule to 10 milijoules.

10. The method of claim 8 wherein said directing of said pulsed laser radiation comprises focusing said pulsed laser radiation to a spot size in the range of 10 to 50 microns.

11. The method of claim 8 wherein said directing of said pulsed laser radiation comprises:
optically coupling an optic switch to said pulsed laser radiation wherein;
said optic switch is optically coupled to a plurality of optical devices.

12. An apparatus for producing a heat affected zone in at least one thin surface layer of metal of a flexure of a suspension comprising:
a radiation device for generating a first beam of pulsed laser radiation;
an optical device for transmitting said first beam of pulsed laser radiation to said steel on said surface of said flexure of said suspension;
a first control system for determining the amount of said pulsed laser radiation required to produce a controlled heat affected zone in at least one thin surface layer of metal of said flexure of said suspension; and
a second control system for determining the location of said pulsed laser radiation on said surface of said flexure of said suspension; wherein said apparatus does not require CW laser radiation in conjunction with said pulsed laser radiation to cause bi-directional angular deflection of a free end of said flexure of said suspension.

13. The apparatus of claim 12 wherein said optical device comprises at least two optical devices for transmitting:
said first beam of pulsed laser radiation to said metal on said surface of said flexure of said suspension; and
said second beam of pulsed laser radiation to an opposite metal surface of said flexure of said suspension.

14. The apparatus of claim 12 wherein said first control system further comprises:
a detection system for monitoring the static attitude of said flexure of said suspension;
a response system for adjusting said exposure variables of said first beam of said pulsed laser radiation; and
a response system for adjusting said exposure variables of said second beam of said pulsed laser radiation.

15. The apparatus of claim 12 wherein said second control system further comprises a servo system for controlling:
commencing of said first beam of pulsed laser radiation;
stopping of said first beam of pulsed laser radiation;
commencing of said second beam of pulsed laser radiation; and
stopping of said second beam of pulsed laser radiation.

16. An apparatus for producing a heat affected zone in at least one thin surface layer of metal of a flexure of an HGA comprising:
a radiation device for generating a first beam of pulsed laser radiation;
an optical device for transmitting said first beam of pulsed laser radiation to said metal on said surface of said flexure of said HGA;
a first control system for determining the amount of said pulsed laser radiation required to produce a controlled heat affected zone in at least one thin surface layer of metal of said flexure of said HGA; and
a second control system for determining the location of said pulsed laser radiation on said surface of said flexure of said HGA; wherein said apparatus does not require CW laser radiation in conjunction with said pulsed laser radiation to cause bi-directional angular deflection of a free end of said flexure of said HGA.

17. The apparatus of claim 16 wherein said optical device comprises at least two optical devices for transmitting:
said first beam of pulsed laser radiation to said metal on said surface of said flexure of said HGA; and
said second beam of pulsed laser radiation to an opposite metal surface of said flexure of said HGA.

18. The apparatus of claim 16 wherein said first control system further comprises:
a detection system for monitoring the static attitude of said flexure of said HGA;
a response system for adjusting said exposure variables of said first beam of said pulsed laser radiation; and
a response system for adjusting said exposure variables of said second beam of said pulsed laser radiation.

19. The apparatus of claim 16 wherein said second control system further comprises a servo system for controlling:
commencing of said first beam of pulsed laser radiation;
stopping of said first beam of pulsed laser radiation;
commencing of said second beam of pulsed laser radiation; and
stopping of said second beam of pulsed laser radiation.

20. An apparatus for producing a heat affected zone in at least one thin surface layer of metal of at least one flexure of an HSA comprising:
a radiation device for generating a first beam of pulsed laser radiation;
an optical device for transmitting said first beam of pulsed laser radiation to said metal on said surface of said flexure of said HSA;
a first control system for determining the amount of said pulsed laser radiation required to produce a controlled heat affected zone in at least one thin surface layer of metal of said flexure of said HSA; and
a second control system for determining the location of said pulsed laser radiation on said surface of said flexure of said HSA; wherein said apparatus does not require CW laser radiation in conjunction with said pulsed laser radiation to cause bi-directional angular deflection of a free end of said flexure of said HGA.
